(19) United States
(12) Patent Application Publication
(10) Pub. No.: US 2014/0305671 A1
(43) Pub. Date: Oct. 16, 2014

(54) Square to Round Ring Assembly, Device, and Method

(71) Applicant: Leszek J. Cwieka, Morton Grove, IL (US)

(72) Inventor: Leszek J. Cwieka, Morton Grove, IL (US)

(21) Appl. No.: 14/253,012

(22) Filed: Apr. 15, 2014

Related U.S. Application Data
(60) Provisional application No. 61/812,300, filed on Apr. 16, 2013.

(51) Int. Cl. H02G 3/08; H02G 3/14

(52) U.S. Cl. CPC H02G 3/081; H02G 3/14
USPC 174/66; 29/428

(57) ABSTRACT

A square-to-round ring device enables a user to selectively mount an electrical device to an electrical box as supported by a support structure. The square-to-round ring device includes a square ring-to-box flat structure and a round device-to-ring attachment structure. The ring-to-box flat structure includes at least one flat-based fastener-receiving structure for receiving at least one fastener. The device-to-ring attachment structure is centrally joined to the ring-to-box flat structure, and includes a number of ring-based fastener-receiving structures, which number of ring-based fastener-receiving structures is greater than two, and preferably four. The ring-based fastener-receiving structures are equally spaced from one another about a periphery of the device-to-ring attachment structure such that two pairs of opposed structures are aligned orthogonally relative to one another in two dimensions. The device-to-ring attachment structure may extend anteriorly from the ring-to-box flat structure. Certain installation methodology is further supported by the inventive device.

### PRIOR HISTORY

This non-provisional patent application claims the benefit of U.S. Provisional Patent Application No. 61/812,300 filed in the United States Patent and Trademark Office on 16 Apr. 2013.

### BACKGROUND OF THE INVENTION

1. Field Of The Invention

The present invention relates generally to an apparatus for transporting or carrying an infant. More particularly, the present invention relates to a low cost assembly and method for carrying or transporting an infant or small child along with other items an infant may find useful.

2. Brief Description of the Prior Art

Certain prior art generally related to the subject invention are briefly described hereinafter. U.S. Pat. No. 7,064,271 ('271 Patent), which issued to Gretz, discloses a Recessed Outlet Box with Breakaway Cover. The '271 Patent describes a recessed electrical box with a breakaway cover. The cover member is rotatably attached to the electrical box and will slip off the box, without any damage to the electrical box or the cover member, if an excessive force is applied to the cover member while it is in the open position. Use of the recessed electrical box positions an electrical device substantially behind the surface of any structure. One or more flanges may be included on the exterior of the electrical box to enable easy positioning with respect to the structure's exterior surface. The flanges may be removable to facilitate installation in a retrofit situation on a finished building.

U.S. Pat. No. 8,084,687 ('687 Patent), which issued to Thurman, discloses an Electrical Outlet Box Assembly. The '687 Patent essentially describes an electrical box assembly is provided for enabling an electrical box to be rapidly installed into a metal framework that supports an interior wall of a building. The assembly includes a supporting member which is attached to the metal framework, and an electrical box of square design having paired outwardly directed flanges. The flanges are positioned to fit into receiving brackets on the supporting member, thereby enabling the electrical box to engage the supporting member by a simple downward sliding motion.

U.S. Pat. No. 8,338,706 ('706 Patent), which issued to Magno, Jr., discloses a Protective Cover. The '706 Patent describes an assembly which includes a mud ring and a detachable cover. The mud ring includes a planar surface including slots for mounting the mud ring to a utility box. The mud ring also includes a raised portion comprising side walls and end walls, the raised portion being elevated with respect to the planar surface. The detachable cover is connected to the raised portion by at least one hinged mechanism, the hinged mechanism being configured to be broken away from the mud ring.

In response, the vendors prepare an offer template provided by the purchaser showing the (components and) services proposed by each vendor and prices associated therewith for supplying the required services. The proposal/offer from each vendor is adjusted to ensure that the offer from each vendor will produce a similar and acceptable result. A downward bidding increments session sets downward bidding that is allowed by the vendor during a subsequent auction process. Each vendor executes a contract that is binding on the vendor if the vendor's bid during a subsequent auction process is accepted as the lowest bid. An auction is held in which each vendor bids against other vendors using the pre-negotiated downward bidding increments.

U.S. Pat. No. 8,598,454 ('454 Patent), which issued to Laughlin, discloses an Electrical Box with Fitting Flanges, and Method of Use. The '454 Patent describes an electrical box which has four sides that define a rectangular space. The box has flanges extending outward from opposite sides, for mounting the box to a stud or other structure. One of the flanges has one or more tabs, outward protrusion(s) that fit into one or more openings in the flange on the opposite side. The fitting of the one or more tabs into the one or more openings allows two such electrical boxes to be conveniently located at the same height, on opposite sides of the stud. The tab(s) and opening(s) automatically align the boxes with each other. The result is an easier and accurate installation, with less time and effort expended.

United States Patent Application No. 2007/0215372, which was authored Kerr, describes a fastening device for mounting an electrical fixture suspended from an electrical junction box in a ceiling. When a mounting bracket assembly suspends the electrical junction box between two joists, the fastening device is an overlay positioned adjacent to each end-plate of the support bar. When the electrical junction box attaches directly to a joist, the fastening device is an overlay positioned inside a cavity of the electrical junction box. The overlay includes fastener openings that position a preset fastener to attach the end-plates to the spaced joists, or openings in the top wall of the cavity to attach the electrical junction box to a joist in the ceiling. The overlay also includes radial incisions, cut in a star pattern, that surround each fastener opening. When an installer tightens all of the fasteners, the star patterns open and allow the installer to easily pull-out and remove the overlay.

United States Patent Application No. 2008/0156513, which was authored by Johnson et al. describes an electrical box assembly which includes an adjustable electrical box cover. The cover includes a base having a central opening and a collar encircling the central opening. A sleeve slides through the collar and is adjusted by a plurality of adjustment screws. In one embodiment, the adjustment screws are positioned within the sleeve and the collar. The sleeve and collar have inwardly extending tabs to receive the adjustment screws allow adjustment of the sleeve with respect to the collar.

United States Patent Application No. 2009/0078442, which was authored by Lin et al., describes an electrical junction box cover system which includes a waterproof dome-like covering lid allowing the system to be installed near water. The system also includes a manual power switch with a manual actuator installed on the outside of the covering lid and accessible to the user. The switch actuator has three positions, wherein the actuator in the first position turns an external load circuit on, in the second position it turns the external circuit off, and in the third position it enables the remotely controlled operation of the external circuit.

A remote control receiver with an electronic control module and an electric power switch are included in the system as an assembly in order to allow a remotely controlled operation of the system. The top mating portion element 20 and the gasket element 25 both show four fastener-receiving constructions that extend radially inward relative to the circumference of the elements 20 and 25.

United States Patent Application No. 2009/0166053, which was authored by Magno, Jr. et al, describes an adjustable cover for an electrical outlet box. The cover is configured having a generally planar mounting plate with a collar surrounding an opening through this mounting plate. An extension sleeve moves within this opening and adjacent the collar. At least one fastener is located adjacent the opening and is movable between a locked position and an unlocked position. The fastener operates a locking device that engages wedges against the extension sleeve when the fastener is in the locked position and disengages wedges against the extension sleeve when the fastener is in the unlocked position.

### SUMMARY OF THE INVENTION

The present invention essentially provides a square-to-round ring device for attachment to a transversely square electrical box. The electrical box usable in combination with the present invention preferably comprises at least two box-based fastener-receiving structures, which box-based fastener-receiving structures are located adjacent diagonally opposite corners of the electrical box, which box is attachable to a load-bearing support member or structure.

The square-to-round ring device according to the present invention preferably comprises a ring-to-box flat structure, and a device-to-ring attachment structure. The ring-to-box flat structure is preferably square in shape and comprises at least one flat-based fastener-receiving structure for receiving at least one fastener. The device-to-ring attachment structure is integrally formed with or joined to the ring-to-box flat structure and is round in shape.

The device-to-ring attachment structure preferably comprises a number of ring-based fastener-receiving structures, which number of ring-based fastener-receiving structures is preferably greater than two, and preferably four. As the reader will note from a comparative inspection of the drawings submitted in support of these specifications, the present invention is basically the increased number of fastener-receiving structures over the state of the art.

In other words, state of the art ring devices comprise two opposed ring-based fastener-receiving structures. The present invention or ring device preferably provides four opposed ring-based fastener-receiving structures. The present invention provides a device that is superior to state of the art ring devices. State of the art ring devices have a shortage of ring-based fastener-receiving structures and require added labor should a user elect to choose to mount an electrical device having an anchor structure with fastener mounts that are or become misaligned depending on the orientation desires of the user with underlying ring-based fastener-receiving structures.

The reader will understand from a comparative inspection of the drawings submitted in support of these specifications, that state of the art ring devices when mounted to an electrical box have a single opposed mount pairing which is typically aligned in either of two dimensions. If a new electrical device is desired, or a new orientation of an existing electrical device is desired, the state of the art ring device must be uncovered, removed from the electrical box, and re-oriented and re-fastened as may be required.

This process is diagrammatically depicted in the figures submitted in support of these specifications and can be very costly to a user, particularly when any given installation may require the process to be repeated a number of times (e.g. if the user wishes to change out all of the electrical devices from a pre-existing installation or to re-orient the existing fixtures from a first orientation to a second preferred orientation).

The present invention or ring device overcomes this obstacle by providing ring-based fastener-receiving structures having both or simultaneous horizontal or first dimensional orientation and vertical or second dimensional orientation. Fasteners fasten the square-to-round ring device according to the present invention to the electrical box such that the number of ring-based fastener-receiving apertures enable the user to selectively fasten an electrical device to the support structure via the electrical box and square-to-round ring device substantially as summarized herein.

The reader will note that the ring-based fastener-receiving structures are equally spaced from one another at 90 rotational degrees bout the periphery of the device-to-ring attachment structure. Further, the reader will note that the ring-based fastener-receiving structures each extend radially inward in the first and second dimensions and each comprise a fastener-receiving aperture. The ring-based fastener-receiving structures preferably extend orthogonally relative to the wall planes of the box walls. The device-to-ring attachment structure may either be coplanar with the ring-to-box flat structure or extend anteriorly therefrom to varying extents.

### BRIEF DESCRIPTION OF THE DRAWINGS

Other features of my invention will become more evident from a consideration of the following brief descriptions of illustrations of the subject invention:

FIG. 1A is an anterior elevational view or depiction of a Prior Art electrical box outfitted with a Prior Art square-to-round ring device such that ring-based fastener-receiving structures are aligned horizontally and juxtapositioned an anterior perspective view of a Prior Art light fixture having an anchor structure with a horizontally aligned fastener mounts.

FIG. 1B is an anterior elevational view or depiction of a Prior Art electrical box outfitted with a Prior Art square-to-round ring device such that ring-based fastener-receiving structures are aligned vertically and juxtapositioned an anterior elevational view of a Prior Art light fixture having an anchor structure with a vertically aligned fastener mounts.

FIG. 2A is an anterior elevational view or depiction of a Prior Art electrical box outfitted with a Prior Art square-to-round ring device such that ring-based fastener-receiving structures are aligned in a first dimension and juxtapositioned a side view depiction of a ceiling mounted Prior Art light fixture having an anchor structure with fastener mounts aligned in the first dimension.

FIG. 2B is an anterior elevational view or depiction of a Prior Art electrical box outfitted with a Prior Art square-to-round ring device such that ring-based fastener-receiving structures are aligned in a second dimension and juxtapositioned a side view depiction of the ceiling mounted Prior Art light fixture otherwise depicted in FIG. 2A as re-oriented such that the fastener mounts of the anchor structure are aligned in the second dimension.

FIG. 3A is a first sequential anterior elevational view or depiction of a Prior Art electrical box outfitted with a Prior Art square-to-round ring device as hidden or obscured behind a façade structure and depicting the hidden ring-based fastener-receiving structures aligned horizontally or in a first dimension.

FIG. 3B is a second sequential anterior elevational view or depiction of a Prior Art electrical box and a Prior Art square-to-round ring device with fasteners being removed and as revealed or viewable through a façade structure with parts broken away and depicting the ring-based fastener-receiving structures aligned horizontally or in a first dimension.

FIG. 3C is a third sequential anterior elevational view or depiction of a revealed or viewable Prior Art electrical box and a Prior Art square-to-round ring device being rotated or re-oriented such that the ring-based fastener-receiving structures are being repositioned from the horizontal or first dimensional alignment toward a vertical or second dimensional alignment.

FIG. 3D is a fourth sequential anterior elevational view or depiction of a revealed or viewable Prior Art electrical box and a Prior Art square-to-round ring device with fasteners being reinserted and depicting the ring-based fastener-receiving structures aligned vertically or in a second dimension.

Figure No. 3E is a fifth sequential anterior elevational view or depiction of a Prior Art electrical box and a Prior Art square-to-round ring device depicting the ring-based fastener-receiving structures aligned vertically or in a second dimension as re-hidden or re-obscured behind a façade patch structure.

FIG. 3F is a sixth sequential anterior elevational view or depiction of a Prior Art electrical box and a Prior Art square-to-round ring device depicting the ring-based fastener-receiving structures aligned vertically or in a second dimension as hidden or obscured behind a façade patch structure being painted.

FIG. 4A is an anterior elevational view or depiction of a Prior Art electrical box mounted to a load-bearing support member and outfitted with a Prior Art square-to-round ring device depicting the ring-based fastener-receiving structures aligned horizontally or in a first dimension.

FIG. 4B is an anterior elevational view or depiction of a Prior Art electrical box mounted to a load-bearing support member and outfitted with a square-to-round ring device according to the present invention depicting two pairs of opposed ring-based fastener-receiving structures aligned both horizontally and vertically.

FIG. 5A is an anterior perspective view or depiction of a Prior Art electrical box mounted to a load-bearing support member and outfitted with a Prior Art square-to-round ring device depicting the ring-based fastener-receiving structures aligned vertically or in a second dimension.

FIG. 5B is an anterior elevational view or depiction of a Prior Art electrical box mounted to a load-bearing support member and outfitted with a square-to-round ring device according to the present invention depicting two pairs of opposed ring-based fastener-receiving structures aligned both horizontally and vertically.

FIG. 6 is an enlarged anterior elevational view or depiction of the structures otherwise depicted in FIG. 5B.

FIG. 7 is an anterior plan view of a square-to-round ring device according to the present invention.

FIG. 8 is an anterior plan view of an alternative electrical box construction according to the present invention having an octagon transverse shape and four box-based fastener-receiving structures extending inwardly defining two pairs of opposed box-based fastener-receiving structures aligned orthogonally relative to one another.

### DETAILED DESCRIPTION OF THE PREFERRED EMBODIMENT AND METHODOLOGY

Referring now to the drawings with more specificity, the present invention essentially provides a square-to-round ring device as depicted and referenced at 10. Viewed systemically, the square-to-round ring device is preferably used in combination with other elements, including a state of the art electrical box as at 11, and at least one, but preferably two state of the art fastener(s) as at 12. The electrical box 11 thus preferably comprises at least two box-based fastener-receiving structures 17, which box-based fastener-receiving structures 17 are located adjacent diagonally opposite corners of the electrical box 11.

The square-to-round ring assembly of components 10, 11, and 12 enable a user to selectively mount a select electrical device or assembly as at 13, 14, and 15 in adjacency to a load-bearing support member as at 16.

The ring device 10 according to the present invention is preferably used in combination with a state of the art electrical box 11 mountable to the load-bearing support member 16. The electrical box 11 preferably comprises a square transverse cross-section and at least one, but preferably two box-based fastener-receiving structure(s) as at 17.

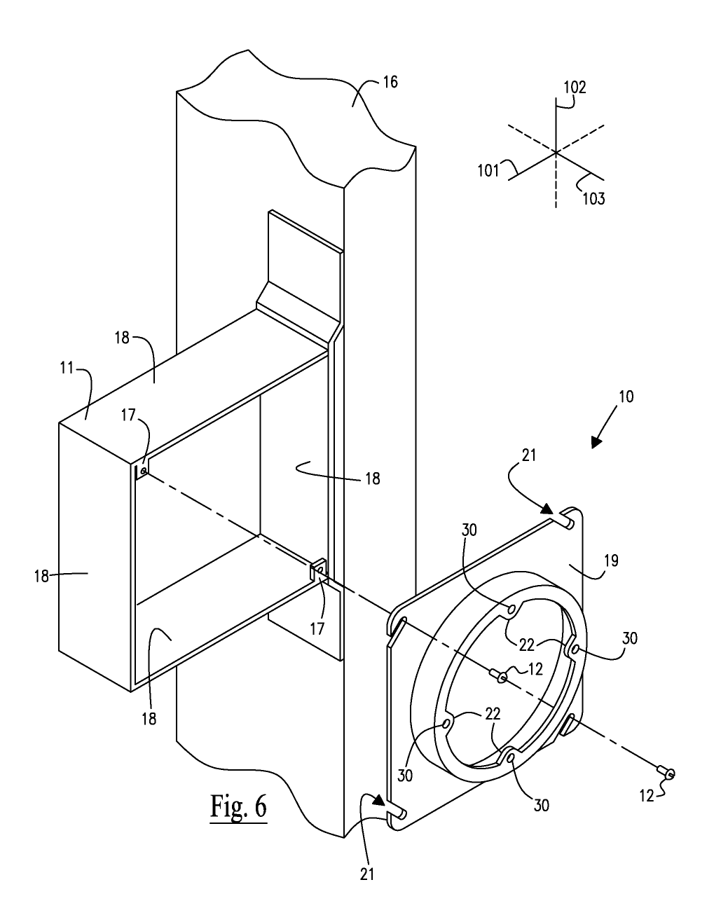

The square transverse cross-section of the electrical box 11 thus comprises four box walls as at 18, which box walls 18 extend in wall planes. The wall planes comprise a first set of parallel planes and a second set of parallel planes. The first set of parallel planes is preferably orthogonal to the second set of parallel planes. Referencing FIG. 6, the reader will please note the Cartesian coordinate diagram 100. A first dimension is labeled 101, a second dimension is labeled 102, and a third dimension is labeled 103.

The first set of wall planes may be defined by the upper box wall 18 and lower box wall 18. The upper and lower box walls 18 each extend in the first and third dimensions 101 and 103. The second set of wall planes may be defined by the laterally right and left walls 18. The second set of wall planes extends in the second and third dimensions 102 and 103. The box-based fastener-receiving structures 17 extend in the first and second dimensions 101 and 102.

The square-to-round ring device 10 preferably comprises a ring-to-box flat structure as at 19, and a device-to-ring attachment structure as at 20. The ring-to-box flat structure is preferably square in shape and comprises at least one flat-based fastener-receiving structure (as exemplified by slot(s) 21) for receiving at least one fastener 12. The device-to-ring attachment structure 20 is integrally formed with or joined to the ring-to-box flat structure 19 and is round in shape.

The device-to-ring attachment structure 20 preferably comprises a number of ring-based fastener-receiving structures as at 22, which number of ring-based fastener-receiving structures 22 is preferably greater than two, and preferably four. As the reader will note from a comparative inspection of the drawings submitted in support of these specifications, the present invention is basically the increased number of fastener-receiving structures 22 over the state of the art.

In other words, state of the art ring devices as at 90 comprise two opposed ring-based fastener-receiving structures 22. The present invention or ring device 10 preferably provides four opposed ring-based fastener-receiving structures 22.

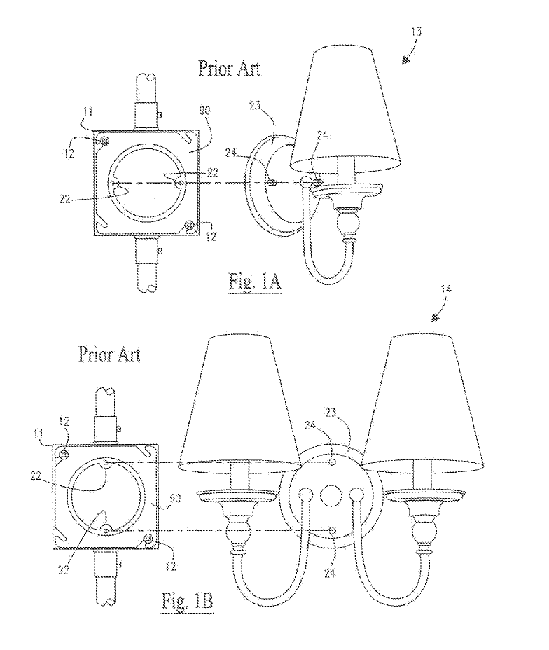

Referencing FIG. 1A through 3F, the present invention provides a device 10 that is superior to state of the art ring devices 90. State of the art ring devices 90, having a shortage of ring-based fastener-receiving structures 22 require added labor should a user elect to choose to mount an electrical device having an anchor structure 23 with fastener mounts 24 that are misaligned with underlying ring-based fastener-receiving structures 22.

Referencing FIG. 1A, the reader will there see a state of the art ring device 90 with horizontally aligned ring-based fastener-receiving structures 22. These horizontally aligned ring-based fastener-receiving structures 22 are mounted upon the electrical box 11 so as to properly mount an electrical device (such as a lamp assembly) as at 13 having an anchor structure 23 with horizontally aligned fastener mounts 24.

Comparing FIG. 1B to FIG. 1A, the reader will see that electrical devices such as the lamp 14 may alternatively comprise anchor structure 23 with vertically aligned fastener mounts 24. The state of the art ring device 90 must accordingly be mounted to the electrical box 11 (via fasteners 12) such that the ring-based fastener-receiving structures 22 are vertically aligned. In these comparative illustrations, if the user wished to remove device 13 and mount device 14 in its place, the state of the art ring device 90 would require re-orientation or adjustment.

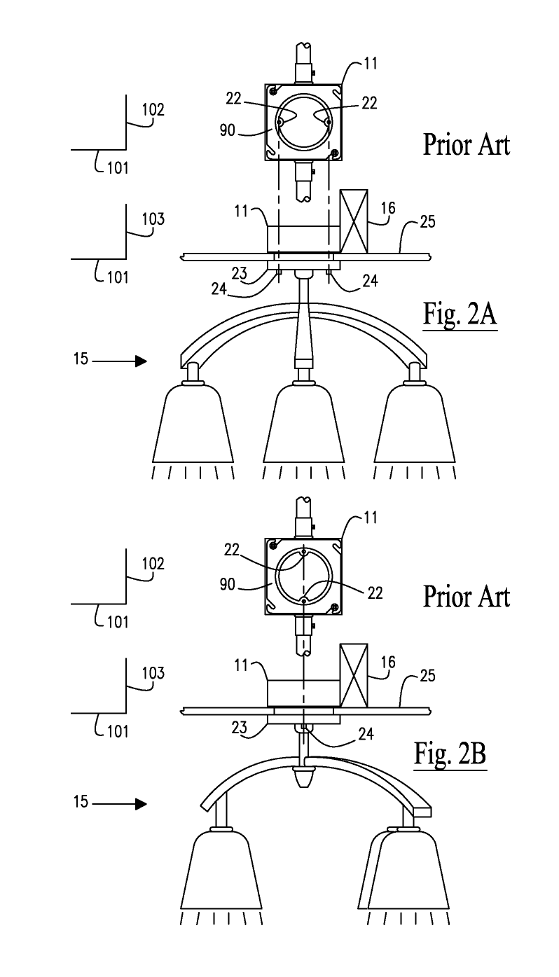

Referencing FIG. 2A, the reader will see a ceiling mounted light fixture 15 there depicted. The ceiling mounted light fixture has an anchor structure with opposed fastener mounts 24. The state of the art ring device 90 is mounted behind the ceiling structure 25 such that the fastener mounts are opposed in the first dimension 101. This enables the light fixture or electrical device 15 to be oriented in a first orientation generally depicted in FIG. 2A.

Should the user wish to re-orient the light fixture or electrical device 15 so as to achieve a second preferred orientation as generally depicted in FIG. 2B, the state of the art ring device 90 would require reorientation or adjustment so as to re-orient or extend the opposed ring-based fastener-receiving structures 22 in the second dimension 102. This re-orientation, however, requires the user to break through the ceiling structure 25 so as to achieve the re-orientation or adjustment.

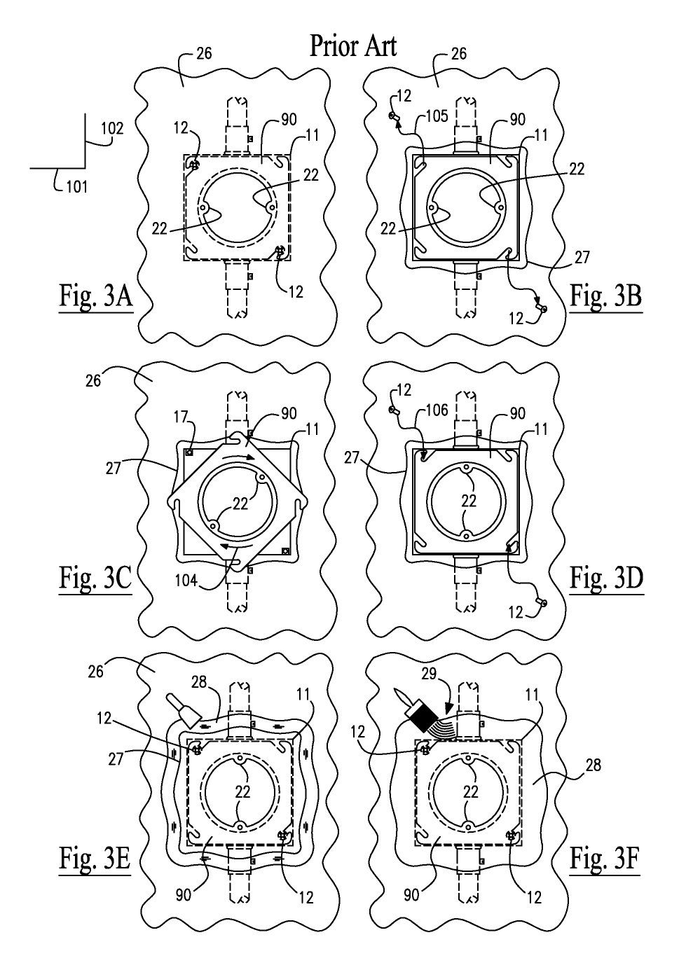

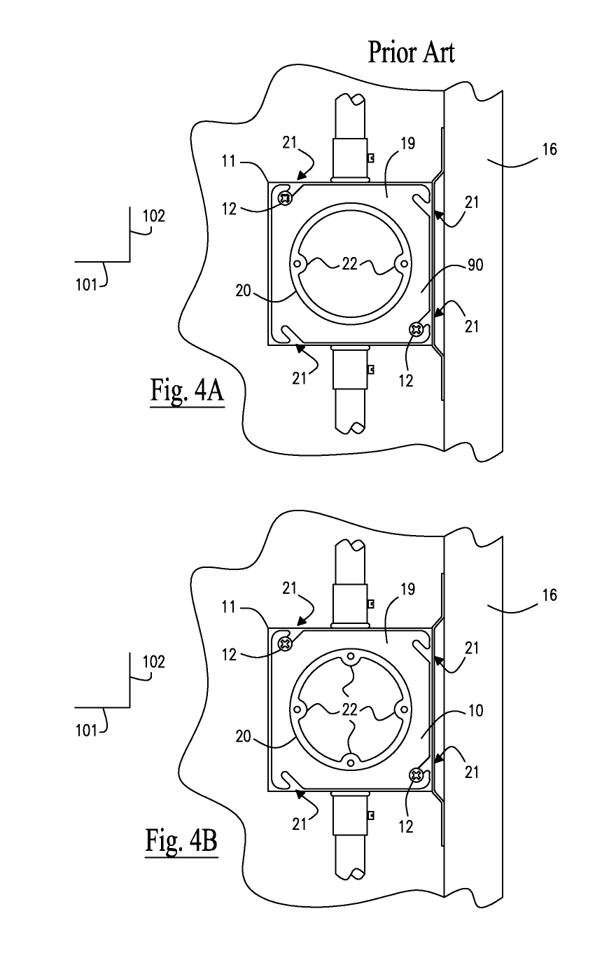

Referencing FIG. 3A through 3F, the reader will see this re-orientation or adjustment diagrammatically depicted. FIG. 3A depicts a state of the art ring device 90 mounted to an electrical box 11 such that the ring-based fastener-receiving structures 22 are aligned horizontally or in the first dimension 101. The electrical box 11 and ring device 90 are shown in broken lines behind generic façade surfacing as at 26.

FIG. 3B depicts the façade surfacing 26 broken away as at 27 to shown the underlying electrical box 11 and ring device 90 in solid lines. To re-orient the ring device 90, ring-to-box fasteners 12 must be removed (as at 105). FIG. 3C depicts the ring device 90 being rotated (as at 104) 45 rotational degrees relative to the orientation depicted in FIG. 3B.

FIG. 3D shows the ring device 90 rotated 90 rotational degrees relative to the orientation depicted in FIG. 3B such that the ring-based fastener-receiving structures 22 are oriented or extend vertically or in the second dimension 102. Having been so oriented, the ring-to-box fasteners 12 are re-fasten (as at 106) the ring device 90 to the electrical box 11.

FIG. 3E depicts the façade structure 26 being patched at the broken away portion 27 so that once again the electrical box 11 and ring device 90 (as re-oriented) are hidden from view. Typically the seam or portion 27 may be covered with some type of putty or similar other material 28, which material 28 is smoothed and painted as at 29 in FIG. 3F.

The process diagrammatically depicted in FIG. 3A through 3F is cumbersome and can be very costly to a user, particularly when any given installation may require the process to be repeated a number of times (e.g. if the user wishes to change out all of the electrical devices from a pre-existing installation or to re-orient the existing fixtures from a first orientation to a second preferred orientation).

The present invention or ring device 10 overcomes this obstacle by providing ring-based fastener-receiving structures 22 having both or simultaneous horizontal (or first dimension 101) orientation and vertical (or second dimension 102) orientation. At least one, but preferably two ring-to-box fasteners 12 fasten the square-to-round ring device 10 according to the present invention to the electrical box 11 such that the number of ring-based fastener-receiving apertures 22 enable the user to selectively fasten an electrical device to the support structure 16 via the electrical box 11 and square-to-round ring device 10 substantially as heretofore described.

The reader will note that the ring-based fastener-receiving structures 22 are equally spaced from one another at 90 rotational degrees bout the periphery of the device-to-ring attachment structure 20. Further, the reader will note that the ring-based fastener-receiving structures 22 each extend radially inward in the first and second dimensions 101 and 102 and each comprise a fastener-receiving aperture as at 30.

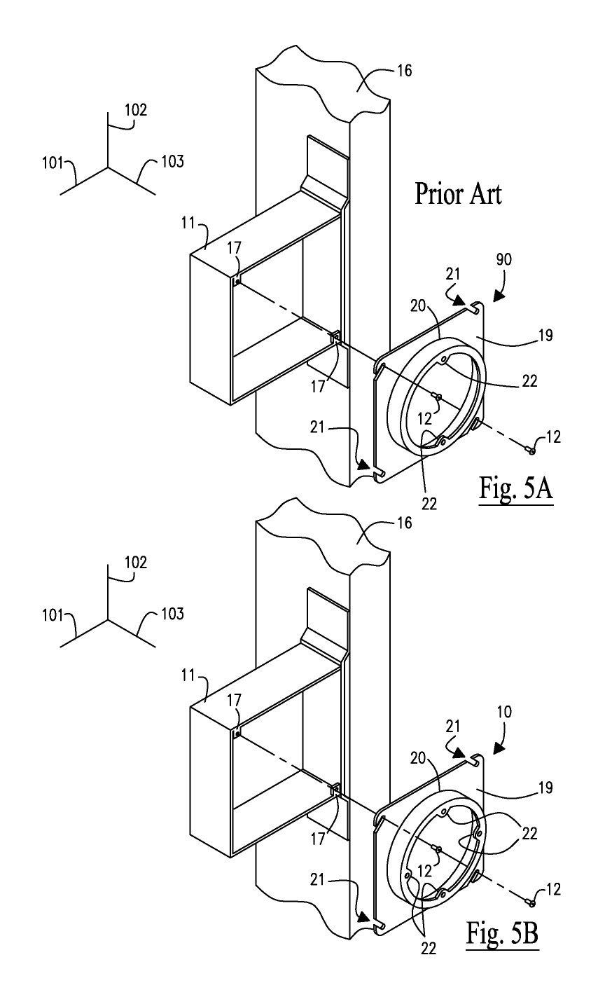

The ring-based fastener-receiving structures 22 preferably extend orthogonally relative to the wall planes. The device-to-ring attachment structure 20 may either be coplanar with the ring-to-box flat structure 19 or extend anteriorly therefrom to varying extents as generally depicted in FIG. 5B and 6.

While the foregoing specifications set forth much specificity, the same should not be construed as setting forth limits to the invention but rather as setting forth certain preferred embodiments and features. For example, as prefaced hereinabove, it is contemplated that the present invention essentially provides a square-to-round ring device as at 10 for enabling a user to selectively mount an electrical device.

The square-to-round ring device 10 according to the present invention is believed to essentially comprise a ring-to-box flat portion or structure as at 19, and a device-to-ring attachment portion or structure as at 20. The ring-to-box flat structure 19 comprises at least one flat-based fastener-receiving structure (as exemplified by slots 21) for receiving at least one ring-to-box fastener as at 12. The device-to-ring attachment structure 20 is centrally joined to the ring-to-box flat structure 19.

Central to the practice of the present invention, the device-to-ring attachment structure 20 according to the present invention preferably comprises a number of ring-based fastener-receiving structures as at 22. The number of ring-based fastener-receiving structures 22 is preferably greater than two, and equal to four. The ring-to-box flat structure 19 preferably square and the device-to-ring attachment structure 20 are preferably round. It is contemplated, however, that certain alternative embodiments could conceivably be employed.

FIG. 8, for example, depicts an octagon shaped electrical box 31 outfitted with box-based fastener-receiving structures 32 that extend inwardly within a plane defined by or parallel to the first and second dimensions 101 and 102 and may extend inwardly from the oblique, octagon-forming corners 33 of the box 31. The corners 33 have corner walls 34, which walls 34 extend in two sets of parallel planes orthogonal to one another.

The box 31 further comprises walls 35, which walls 35 extend in two sets of parallel planes orthogonal to one another. The fastener-receiving structures, while shown extending inwardly orthogonal to the corner walls 34, may alternatively be extended inwardly orthogonally from the walls 35 and still be within the spirit of the present invention.

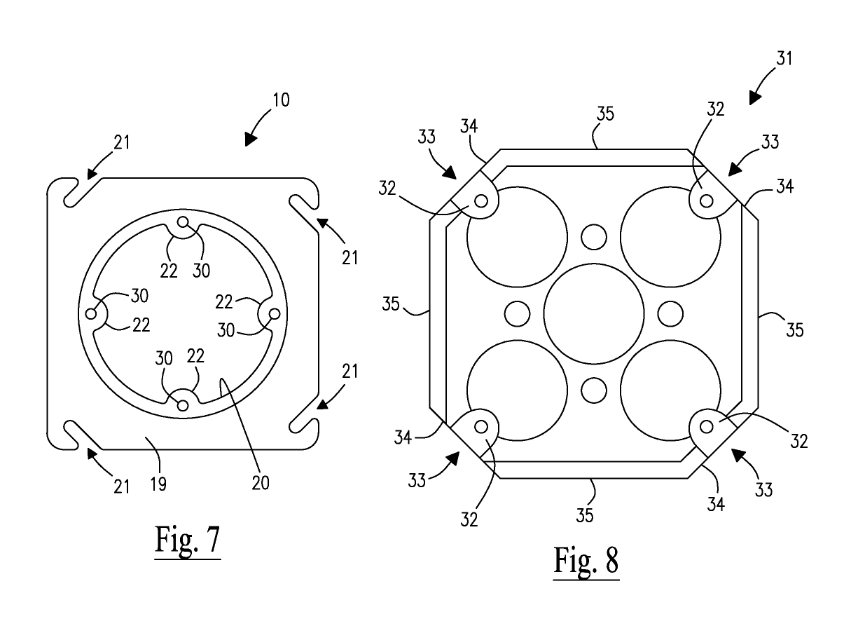

It is thus contemplated that the present invention basically provides an electrical anchor construction as preferably embodied by ring device 10 generally shown in FIG. 7 or alternatively as the box construction as at 31 in FIG. 8. The electrical anchor construction(s) according to the present invention enable a user to selectively mount an electrical device, and essentially comprise(s) a number of device-to-device fastener-receiving structures as exemplified by either structures 22 or structures 32. The number of device-to-device fastener-receiving structures is greater than two, and preferably four, which four structures comprise two pairs of opposed structures, each set of which is aligned in either a first dimension or a second dimension.

In addition to the various structural aspects of the invention, it is believed that the foregoing specifications further support certain electrical device installation methods for enabling a user to selectively mount an electrical device. The electrical device installation method according to the present invention is believed to comprise the steps of mounting an electrical box as at 11 or 31 to a support structure as at 16.

The electrical box 11 or 31 comprises a transverse cross-section and at least one box-based fastener-receiving structure as at 17 or 32. The transverse cross-section comprises at least four box walls, which four box walls extend in certain wall planes. The wall planes comprise a first set of parallel planes and a second set of parallel planes. The first set of parallel planes is preferably orthogonal to the second set of parallel planes.

A square-to-round ring device may then be fastened to the electrical box. The square-to-round ring device according to the present invention comprises a ring-to-box flat structure and a device-to-ring attachment structure. The ring-to-box flat structure comprises at least one flat-based fastener-receiving structure for receiving at least one fastener. The device-to-ring attachment structure is centrally joined to the ring-to-box flat structure, and comprises a number of ring-based fastener-receiving structures, which number of ring-based fastener-receiving structures is greater than two.

An orientation for an electrical device is then selected. The electrical device has pre-formed, device-based fastener-receiving structure as at fastener mounts 24 formed in the anchor structure 23. The select orientation of the electrical device is primarily based on the pre-formed, device-based fastener-receiving structure.

The electrical device is then selectively mounted in the select orientation in adjacency to the support structure via the electrical box and square-to-round ring device via at least one fastener. The pre-formed, device-based fastener-receiving structure is aligned with a select set of ring-based, fastener-receiving structures, which select set of ring-based, fastener-receiving structures are selected from a group consisting of the number of ring-based, fastener-receiving structures.

Accordingly, although the invention has been described by reference to certain preferred embodiments and certain methodologies, it is not intended that the novel arrangement and methods be limited thereby, but that modifications thereof are intended to be included as falling within the broad scope and spirit of the foregoing disclosures, the appended drawings, and the following claims.

I claim:

1. A square-to-round ring assembly, the square-to-round ring assembly for enabling a user to selectively mount an electrical device, the square-to-round ring assembly comprising, in combination:
an electrical box, the electrical box comprising a square transverse cross-section and at least one box-based fastener-receiving structure, the square transverse cross-section comprising four box walls, the four box walls extending in wall planes, the wall planes comprising a first set of parallel planes and a second set of parallel planes, the first set of parallel planes being orthogonal to the second set of parallel planes, the electrical box being mountable to a support structure;
a square-to-round ring device, the square-to-round ring device comprising a square ring-to-box flat structure and a round device-to-ring attachment structure, the ring-to-box flat structure comprising at least one flat-based fastener-receiving structure for receiving at least one fastener, the device-to-ring attachment structure being centrally joined to the ring-to-box flat structure, the device-to-ring attachment structure comprising a number of ring-based fastener-receiving structures, the number of ring-based fastener-receiving structures being greater than two; and
at least one ring-to-box fastener, the at least one ring-to-box fastener for fastening the square-to-round ring device to the electrical box, the number of ring-based fastener-receiving apertures for enabling a user to selectively fasten an electrical device to the electrical box and square-to-round ring device via device-to-ring fastener structures.

2. The square-to-round ring assembly of claim 1 wherein the ring-based fastener-receiving structures are equally spaced from one another about a periphery of the device-to-ring attachment structure.

3. The square-to-round ring assembly of claim 2 wherein the number of ring-based fastener-receiving structures is four.

4. The square-to-round ring assembly of claim 3 wherein the ring-based fastener-receiving structures each extends radially inward.

5. The square-to-round ring assembly of claim 4 wherein the ring-based fastener-receiving structures respectively extend orthogonally relative to the wall planes.

6. The square-to-round ring assembly of claim 5 wherein the device-to-ring attachment structure extends anteriorly from the ring-to-box flat structure.

7. The square-to-round ring assembly of claim 6 wherein the electrical box comprises at least two box-based fastener-receiving structures, the box-based fastener-receiving structures being located adjacent diagonally opposite corners of the electrical box.

8. An electrical anchor construction for enabling a user to selectively mount an electrical device, the electrical construction comprising:
a number of device-to-device fastener-receiving structures, the number of device-to-device fastener-receiving structures being greater than two.

9. The electrical anchor construction of claim 9 wherein the electrical anchor construction is defined by a square-to-round ring device, the square-to-round ring device comprising a ring-to-box flat structure and a device-to-ring attachment structure, the ring-to-box flat structure comprising at least one flat-based fastener-receiving structure for receiving at least one fastener, the device-to-ring attachment structure being centrally joined to the ring-to-box flat structure, the device-to-ring attachment structure comprising a number of ring-based fastener-receiving structures, the number of ring-based fastener-receiving structures being greater than two.

10. The square-to-round ring device of claim 9 wherein the ring-to-box flat structure is square and the device-to-ring attachment structure is round.

11. The square-to-round ring device of claim 10 wherein the ring-based fastener-receiving structures are equally spaced from one another about the periphery of the device-to-ring attachment structure.

12. The square-to-round ring device of claim 11 wherein the number of ring-based fastener-receiving structures is four.

13. The square-to-round ring device of claim 12 wherein the ring-based fastener-receiving structures each extend radially inward.

14. The square-to-round ring device of claim 13 wherein the device-to-ring attachment structure extends anteriorly from the ring-to-box flat structure.

15. An electrical device installation method for enabling a user to selectively mount an electrical device, the electrical device installation method comprising the steps of:
mounting an electrical box to a support structure, the electrical box comprising a transverse cross-section and at least one box-based fastener-receiving structure, the transverse cross-section comprising four box walls, the four box walls extending in wall planes, the wall planes comprising a first set of parallel planes and a second set of parallel planes, the first set of parallel planes being orthogonal to the second set of parallel planes;
fastening a square-to-round ring device to the electrical box, the square-to-round ring device comprising a ring-to-box flat structure and a device-to-ring attachment structure, the ring-to-box flat structure comprising at least one flat-based fastener-receiving structure for receiving at least one fastener, the device-to-ring attachment structure being centrally joined to the ring-to-box flat structure, the device-to-ring attachment structure comprising a number of ring-based fastener-receiving structures, the number of ring-based fastener-receiving structures being greater than two; and
selecting an orientation for an electrical device, the electrical device having pre-formed, device-based fastener-receiving structure, the select orientation being based on the pre-formed, device-based fastener-receiving structure; and
selectively mounting the electrical device in the select orientation in adjacency to the electrical box and square-to-round ring device via at least one device-to-ring fastener, the pre-formed, device-based fastener-receiving structure being aligned with a select set of ring-based, fastener-receiving structures, the select set of ring-based, fastener-receiving structures being selected from a group consisting of the number of ring-based, fastener-receiving structures.

16. The electrical device installation method of claim 15 wherein the ring-based fastener-receiving structures are equally spaced from one another about the periphery of the device-to-ring attachment structure.

17. The electrical device installation method of claim 16 wherein the number of ring-based fastener-receiving structures is four.

18. The electrical device installation method of claim 17 wherein the ring-based fastener-receiving structures each extend radially inward respectively orthogonally relative to the wall planes.

19. The electrical device installation method of claim 18 wherein the device-to-ring attachment structure extends anteriorly from the ring-to-box flat structure.

20. The electrical device installation method of claim 19 wherein the electrical box comprises at least two box-based fastener-receiving structures, the box-based fastener-receiving structures being located adjacent diagonally opposite corners of the electrical box.
